(19) United States
(12) Patent Application Publication
(10) Pub. No.: US 2016/0371773 A1
(43) Pub. Date: Dec. 22, 2016

(54) METHOD BY TRADING OF SERVICES AND/OR PRODUCTS BETWEEN USERS THROUGH EXCHANGE TRANSACTIONS

(71) Applicants: Ole JAGTBOE, Kobenhavn V (DK); Poul Anders HANSEN, Roskilde (DK)

(72) Inventors: Ole JAGTBOE, København V (DK); Poul Anders HANSEN, Roskilde (DK)

(21) Appl. No.: 14/392,062

(22) PCT Filed: Feb. 14, 2014
(86) PCT No.: PCT/DK2014/000012

§ 371 Date: Jul. 24, 2015

(30) Foreign Application Priority Data
Feb. 15, 2013 (DK) PA 2013 00090

(51) Int. Cl. G06Q 40/04

(52) U.S. Cl. CPC G06Q 40/04

(57) ABSTRACT

In order to facilitate trading of objects by exchanging these objects between users (P) that offers or requests objects (s,k) in a way where reliable contact information between the users are provided only when the objects a one user request to offer and request match the object another user request to offer or request. In order to achieve this a method is provided in which all objects offered or requested are classified by an administrator in a classification system, When an object offered or requested by a user matches another users object, where match is determined in a calculation unit bycomparison of the classified objects, then the users identifications are transferred to the respective users after having paid fee for getting the identification in form of contact details.

### BACKGROUND OF THE INVENTION

1. Field of the invention.

This invention relates to a method by trading of objects such as services and/or products between users through exchanging the objects.

2. Description of the prior art

In US 2012/0024232 A1 a method in exchanging product a courier provide delivering services is disclosed.

Moreover US 2012/0296757 discloses a method in exchanging products.

In this method a lot of cumbersome administrative process is involved.

### SUMMARY OF THE INVENTION

In is therefore a purpose with the present invention to provide a method, where administrative processes are, limited to the necessary.

Further a reliable method in providing contacts between users offering and/or requesting products of any type by identification the products irrespective of the type of objects requested/offered is provided.

The purpose of the invention is provided by a method defended above that comprising the following steps:
a. The users stores their name, address and email in a registration unit
b. A number of the users register what objects they offer as an exchange object
c. A number of the users register what object they request to receive as an exchange object
d. A number of users register what objects they offer as an exchange object and what objects they request to receive as an exchange object
e. The selected objects are by an administrator technically classified according to the type of the objects using a technical classification system, thereby creating technical values representing the type of objects, said values are transferred and stored in a table
f. A calculation unit compares the stored technical values in the table.
g. By an appropriate match between the stored technical classified values derived from the comparison in the calculation unit, the users' identification is registered.

It is advantageous that in case of a match the users identification are informed about their mutual identity, and as stated in claim 3 that the mutual identity is given to the users after having paid a fee.

In order to manage all kind of objects it is favourable that the is administrator allocate a miscellaneous class for objects in case an object are not suitable placed in an existing class.

To get the method available no matter where the users are, it is expedient that the users registration is done by a communication unit, and, that the communication unit is a PC, tablet, a smartphone, an Iphone, an android device, a windows phone or the like.

### BRIEF DESCRIPTION OF THE DRAWINGS

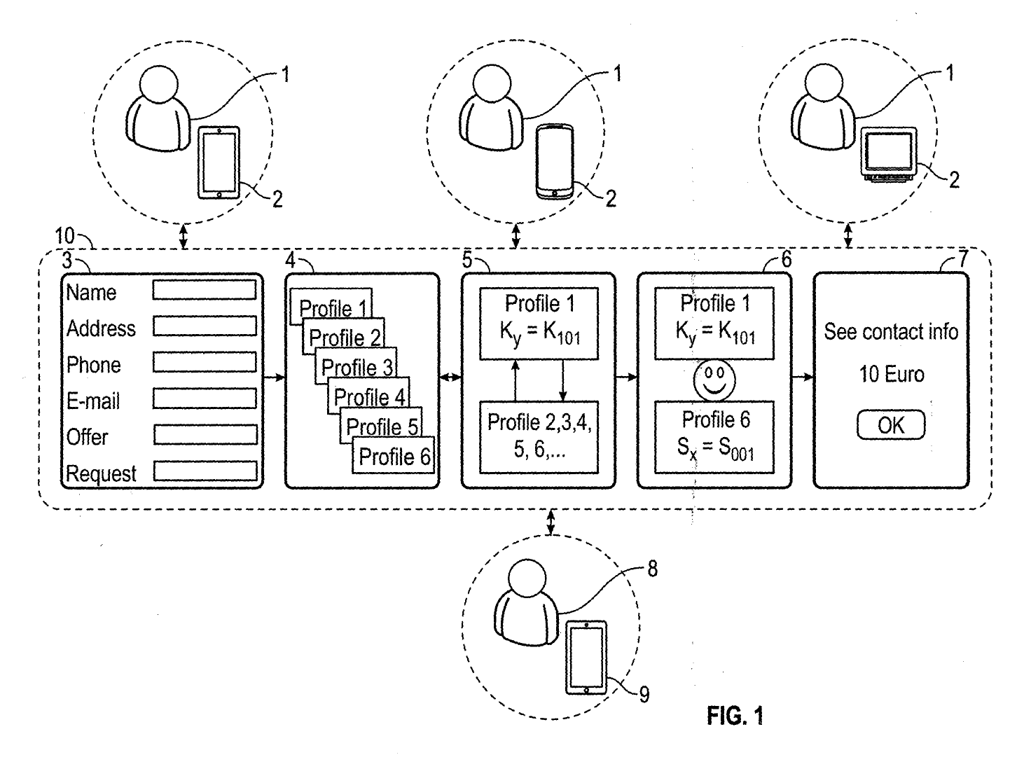

The invention will now be explained in connection with the only FIG. 1 on the drawing.

### DETAILED DESCRIPTION

On the FIG. 1, 1 denotes a number of users, each having a communication unit 2, such as a PC, tablet, Ipad, smartphone, such as an Iphone, a windows phone, an android phone or the like.

10 denotes a computer that is wireless connected to the communication units 2.

The computer 10 has a registration unit 3 adapted to register a users name, address, phone number, address, email or the like.

Moreover the user register the objects they want to offer or want to get in the request field.

5 denotes a calculation unit in which a comparison between the classes relating to the users offers or requests of objects that are summarized in a table 4. This table is more specific shown below.

8 denotes an administrator that classifies all objects transferred by the users, and transferred to the table shown below.

This classification can as an example be done by using the international trademark system.

In case an object it not immediately easy to classify then the object is is given a residual class.

The administrator currently maintain the classifications and updatings of the same.

If now there is match between a users offer, and another users request, then this information is transferred to a display 6 corresponding to f. inst. the users P₁ offer and P₆ request in the table.

The user can now on the display see the result.

Before transferring contact details between the two users a fee, see 7 on FIG. 1, has to be paid, said fee can be set to 0 f. inst. in an introduction period, of the system.

The table 4 mentioned above and shown below function as follows:

On the headline of the table the following denotations are provided.

Pₚ denotes a user that request to register.

Sₓ denotes an object the user want to offer through an exchange trading.

K_{y} denotes an object a user want to request though an exchange trading.

The table is to be understood as follows:

The user P₁ offer plumber service S₀₀₁ and request removal of a wisdom tooth K₁₀₁.

From the table it can be seen that a perfect match exists between the users P₁ and P₆, since P₁ offer removal of a wisdom teeth and P₆ request plumber service.

P₂ illustrates how the table can be divided by subgroups, f. inst. a cosmetic treatment of a tooth is a subgroup K₁₀₁ₐ to a general toot treatment K₁₀₁, whereas replacement of a toilet S₀₀₁ₐ is subgroup to plumber service S₀₀₁.

P₄ illustrates a user that request white goods service S₀₀₃, but do not want a particular offer.

P₅ illustrates a user that request IT service K₀₀₄ but have nothing to offer. Finally Pₓ illustrates a user where it was not possible to allocate a specific type that is offered or requested. This is denoted miscellaneous and is survived by the administrator that when a more specified class is created will allocate the class.

In summary the invention can be explained as follows:

Users is able to register in a database by providing information about one or two objects S, K, being part of an exchange trading.

The objects are classified by an administrator in principle as it is done by classifying patent or trademarks. The trademark classification is the most suitable classification system for the method here described.

The users have the following opportunities:

A user can offer an object S such as a product, goods or service.

As a consideration another user request an object K such as a product, goods or service.

This is illustrated in the table above, f. inst. under P₆.

It is also possible that the users can offer an object without claiming consideration.

This is illustrated with P₄ in the table.

It is also possible that the user can request an object without claiming any offer.

This is illustrated as P₅ in the table.

If a user chose P₄ or P₅ then the both determined product can be allocated the miscellaneous class as explained above.

By the method, a lot of flexible opportunities in trading products, goods or services through exchange operations, in which the searching possibilities in order to locate the appropriate products, goods or services for the users are facilitated where the users can offer, request or both in a reliable and flexible manner.

Even that the invention is explained in connection with exchange transactions, it is possible also to implement the invention in connection with sales and buy of objects.

TABLE

| Pₚ | | |
|---|---|---|
| E-mail | Sₓ | K_{y} |
| Name | Code for service or | Code for service or |
| Address | objects offered | objects requested |
| P₁ | S₀₀₁ | K₁₀₁ |
| | Plumber service | Removal of a wisdom |
| | | teeth |
| P₂ | S₀₀₁ₐ | K₁ₒ₁ₐ |
| | Replacement of a | Cosmetic treatment of |
| | toilet | teeth |
| P₃ | S₀₀₂ | K₁₀₂ |
| | Car offer | Sommer House |
| | | renovation |
| P₄ | S₀₀₃ | — |
| | White goods service | |
| P₅ | — | K₁₀₄ |
| | | IT service |
| P₆ | S₀₀₁ | K₁₀₁ |
| | Tooth treatment | Plumber service |
| Pₓ | S₀ₓₓ | K_{1yy} |
| | Miscellenous | Miscellenous |

1. Method by trading of objects such as services and/or products between users through exchanging the objects comprising the following steps:
a. The users stores theft name, address and email in a registration unit
b. A number of the users register what objects they offer as an exchange object
c. A number of the users register what object they request to receive as an exchange object
d. A number of users register what objects they offer as an exchange object and what objects they request to receive as an exchange object
e. The selected objects are by an administrator technically classified according to the type of the objects using a technical classification system, thereby creating technical values representing the type of objects, said values are transferred and stored in a table
f. A calculation unit compares the stored technical classified values in the table
g. By an appropriate match between the stored technical classified values derived from the comparison in the calculation unit, the users' identification is registered.

2. Method according to claim 1, wherein in case of a match the users identification are informed about their mutual identity.

3. Method according to claim 2, wherein in the mutual identity is given to the users after having paid a fee.

4. Method according to 3, wherein that the administrator allocate a miscellaneous class for services or products in case a service or goods are not suitable placed in an existing class.

5. Method according to claim 1, wherein the users registration is done by a communication unit.

6. Method according to claim 5, wherein the communication unit is a PC, tablet, a smartphone, an Iphone, an android device, a windows phone or the like.
